(19) United States
(12) Patent Application Publication
(10) Pub. No.: US 2023/0384884 A1
(43) Pub. Date: Nov. 30, 2023

(54) TOUCH PANEL AND DISPLAY MODULE

(71) Applicant: HKC CORPORATION LIMITED, Shenzhen (CN)

(72) Inventors: Wang LI, Shenzhen (CN); Rongrong LI, Shenzhen (CN)

(73) Assignee: HKC CORPORATION LIMITED, Shenzhen (CN)

(21) Appl. No.: 18/066,819

(22) Filed: Dec. 15, 2022

(30) Foreign Application Priority Data
May 31, 2022 (CN) 202210612124.X

(51) Int. Cl. G06F 3/041; G06F 3/044

(52) U.S. Cl. CPC G06F 3/04164; G06F 3/0448; G06F 2203/04111; G06F 2203/04107; G06F 3/0443

(57) ABSTRACT

Disclosed are a touch panel and a display module. The touch panel includes a substrate provided with a touch area, which is provided with a first touch channel and a second touch channel, the second touch channel is insulated from the first touch channel, the second touch channel includes at least two second electrode units spaced in a second direction, the first direction intersects the second direction, the first touch channel is provided between two adjacent second electrode units and insulated from two adjacent second electrode units, the touch panel further includes a crossing unit provided on the substrate and provided between two adjacent second electrode units, the crossing unit is insulated from the first touch channel; and an electrical connection bridge is configured to electrically connect the two second electrode units on both sides of the crossing unit to the crossing unit.

### CROSS-REFERENCE TO RELATED APPLICATIONS

The present application claims priority to Chinese Patent Application No. 202210612124.X, filed on May 31, 2022, the entire contents of which are incorporated herein by reference.

### TECHNICAL FIELD

The present application relates to the field of touch technology, and in particular to a touch panel and a display module applying the touch panel.

### BACKGROUND

The touch technology will develop well. With the increasing number of electronic products with screens, in addition to traditional cell phones and laptops, etc., products such as car/wear/refrigerator/audio are added with screens. The touch function on the screen, as the direct experience of the product and means of interaction, becomes more and more important.

However, existing touch panels include horizontal touch channels and vertical touch channels that are intersected and insulated from each other, and each touch channel includes multiple interconnected rhombus-shaped touch patterns, rhombus-shaped touch patterns in the two adjacent vertical touch channels are usually regularly connected through the electrical connection bridge in an up-down vertical direction. A length of the electrical connection bridge designed is too long, when the screen is displayed, especially the white screen is displayed, the electrical connection bridge is touched to block the backlight, the electrical connection bridge is visible when facing up to the white screen, the display effect is affected, and not conducive to the optical performance of the product is improved.

### SUMMARY

The main purpose of the present application is to propose a touch panel, to reduce the visibility of electrical connection bridges.

In order to achieve the above purpose, the touch panel provided by the present application includes: a touch panel, including a substrate, the substrate is provided with a touch area, the touch area is provided with a first touch channel and a second touch channel, the first touch channel extends in a first direction, the second touch channel is insulated from the first touch channel, the second touch channel comprises at least two second electrode units spaced in a second direction, the first direction intersects the second direction, the first touch channel is provided between two adjacent second electrode units and insulated from two adjacent second electrode units, the touch panel further includes:

a crossing unit provided on the substrate and provided between two adjacent second electrode units, the crossing unit being insulated from the first touch channel; and

an electrical connection bridge configured to electrically connect the two second electrode units on both sides of the crossing unit to the crossing unit, an extension direction of the electrical connection bridge forming an acute angle with the second direction.

In an embodiment, edges of the crossing unit are at least partially surrounded by the first touch channel.

In an embodiment, the first touch channel is opened with an avoidance hole, hole walls of the avoidance hole are enclosed to form a closed space, the crossing unit is provided in the closed space, and a gap is provided between the crossing unit and the hole walls of the avoidance hole.

In an embodiment, the crossing unit is connected with two electrical connection bridges, one electrical connection bridge is connected to the second electrode unit on one side of the crossing unit, the other electrical connection bridge is connected to the second electrode unit on the other side of the crossing unit, and the two electrical connection bridges form an angle.

In an embodiment, the first touch channel includes at least two first electrode units spaced in the first direction, two adjacent first electrode units are connected to each other by a connecting electrode, the connecting electrode is spaced from the second electrode unit, and the crossing unit crosses the connecting electrode and the two first electrode units.

In an embodiment, the crossing unit includes a first crossing portion, a second crossing portion, and a connecting portion, the first crossing portion and the second crossing portion are surrounded by two adjacent first electrode units respectively, the connecting portion is surrounded by the connecting electrode and connects the first crossing portion and the second crossing portion, and two electrical connection bridges are connected to the first crossing portion or the second crossing portion.

In an embodiment, the touch panel includes at least two first touch channels provided at intervals with the second electrode unit, the first crossing portion of one of two adjacent first touch channels is electrically connected to the electrical connection bridge, and the second crossing portion of the other of two adjacent first touch channels is electrically connected to the electrical connection bridge.

In an embodiment, two adjacent first electrode units in the first direction are defined as a first sub-electrode unit and a second sub-electrode unit, the first crossing portion is provided on a side of the first sub-electrode unit near the second sub-electrode unit, and the second crossing portion is provided on a side of the second sub-electrode unit near the first sub-electrode unit.

In an embodiment, the first electrode unit is of rhombus, polygon or circle; and/or the second electrode unit is of rhombus, polygon or circle; and/or the first crossing portion is of polygon, rhombus or circle; and/or the second crossing portion is of polygon, rhombus or circle.

The present application also provides a display module, including a display panel and a touch panel, the touch panel is located on a light emitting side of the display panel.

In the technical solution of the present application, the crossing unit is provided between two adjacent second electrode units and is insulated from the first touch channel, the two adjacent second electrode units in the second touch channel is connected to the crossing unit through the electrical connection bridge, thus two adjacent second electrode units are electrically connected through the electrical connection bridge and the crossing unit. In addition, by providing a crossing unit, two adjacent second electrode units can be connected to the crossing unit through the electrical connection bridge, instead of directly connecting two ends of the electrical connection bridge to the two second electrode units on both sides of the crossing unit, thus a length of a single electrical connection bridge is shortened. An extension direction of the electrical connection bridge forms an acute angle with the second direction, so that the electrical connection bridges are not distributed in a line, thus the visibility of the bridge is weakened.

### BRIEF DESCRIPTION OF THE DRAWINGS

In order to more clearly illustrate the technical solutions in the embodiments of the present application or in the prior art, the drawings in the description of the embodiments or prior art will be simply introduced as below. Obviously, the drawings in the following description are only some embodiments of the present application, and other structures can be obtained by those skilled in the art according to structures illustrated in these drawings without any creative work.

FIG. 1 is a structural schematic view of a touch panel according to an embodiment of the present application.

FIG. 2 is a partially enlarged view at A position in FIG. 1.

FIG. 3 is a partially structural schematic view in FIG. 1.

FIG. 4 is a structural schematic view of a display module according to an embodiment of the present application.

The realization of the purpose, functional features and advantages of the present application will be further described with reference to the drawings, in conjunction with the embodiments.

### DETAILED DESCRIPTION OF THE EMBODIMENTS

The technical solutions in the embodiments of the present application will be clearly and completely described below in conjunction with the drawings in the embodiments of the present application, and it is clear that the described embodiments are only a part of the embodiments of the present application, and not all of them. Based on the embodiments in the present application, all other embodiments obtained by those skilled in the art without any creative labor fall within the scope of protection of the present application.

It should be noted that if directional indications (such as up, down, left, right, forward, back) appear in the embodiments of the present application, the directional indications are used only to explain the relative position relationship, movement, etc. among the components in a particular attitude (as shown in the attached drawings), and if the particular attitude is changed, the directional indications are also changed accordingly.

In addition, if there are terms “first”, “second”, etc. in an embodiment of the present application, the terms “first”, “second”, etc. are used only for descriptive purposes and are not to be understood as indicating or implying its relative importance or implicitly specifying the number of indicated technical features. Thus, features defined with terms “first”, “second” may explicitly or implicitly include at least one such feature. In addition, the technical solutions of each embodiment may be combined with each other, but only on the basis that they can be realized by those skilled in the art, and when a combination of technical solutions is contradictory or unrealizable, it shall be considered that such combination of technical solutions does not exist and is not within the scope of protection claimed by the present application.

The present application proposes a touch panel 100.

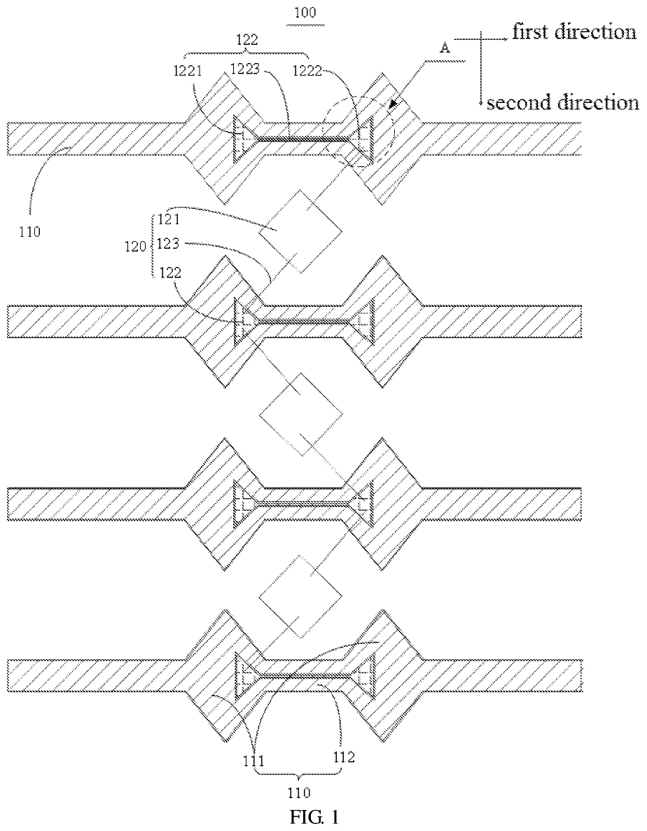

In the embodiment, as shown in FIG. 1, the touch panel 100 includes a substrate, the substrate is provided with a touch area, the touch area is provided with a first touch channel 110 and a second touch channel 120. The first touch channel 110 extends in the first direction, the second touch channel 120 is insulated from the first touch channel 110. The second touch channel 120 includes at least two second electrode units 121, the at least two second electrode units 121 are spaced in the second direction. The first direction intersects the second direction. The first touch channel 110 is provided between two adjacent second electrode units 121 and insulated from two adjacent second electrode units 121. The touch panel 100 also includes a crossing unit 122 and an electrical connection bridge 123. The crossing unit 122 is provided on the substrate. The crossing unit 122 is provided between two adjacent electrode units. The crossing unit 122 is insulated from the first touch channel 110. Two second electrode units 121 on both sides of the crossing unit 122 are electrically connected to the crossing unit 122 through the electrical connection bridge 123. An extension direction of the electrical connection bridge 123 forms an acute angle with the second direction.

The substrate of the touch panel 100 is a basis for setting the first touch channel 110 and the second touch channel 120. The first touch channel 110 can be a touch driving electrode and the second touch channel 120 can be a touch sensing electrode. When the user touches the touch panel 100 through the finger, the first touch channel 110 is used to transmit the touch driving signal, the second touch channel 120 is used to receive the sensing signal. The touch panel 100 also includes a driving chip, the driving chip confirms a location of the finger touch and/or pressure according to the first touch channel 110 and the second touch channel 120. The first touch channel 110 extends in the first direction, the second touch channel 120 includes at least two second electrode units 121, the at least two second electrode units 121 are spaced in the second direction, and the first direction intersects the second direction. The first touch channel 110 is provided between two adjacent second electrode units 121 and insulated from two adjacent second electrode units 121, then the user touches the touch panel 100 with the finger, the first touch channel 110 and the second touch channel 120 can quickly in time transmit the signal to the driving chip. The first touch channel 110 may be an elongated touch channel extending in the first direction, or the first touch channel 110 may also be formed by a plurality of first electrode units 111 spaced in series in the first direction. The outer contour pattern of the first electrode unit 111 can be rectangular, rhombus-shaped, circular, triangular or other shapes, etc., two adjacent first electrode units 111 can be electrically connected by the same layer of linear electrodes or through other shapes of electrodes. The outer contour pattern of the second electrode unit 121 can also be rectangular, rhombus-shaped, circular, triangular or other shapes, etc.

In order to facilitate the electrical connection of two adjacent second electrode units 121 in the second touch channel 120, the touch panel 100 is also provided with a crossing unit 122 and an electrical connection bridge 123, the second electrode unit 121 in the second touch channel 120 can be electrically connected through the crossing unit 122. Moreover, the crossing unit 122 is provided between two adjacent second electrode units 121. Compared with a technical solution that two traditional adjacent second electrode units 121 are directly connected through the electrical connection bridge 123, the second electrode unit 121 in the present application is connected to the crossing unit 122 through the electrical connection bridge 123, the length of the projection of the electrical connection bridge 123 on the substrate will be shorter than the projection of the electrical connection bridge 123 on the substrate in the traditional solution, thus the degree of visualization of the bridge 123 is weaken. The crossing unit 122 and the first touch channel 110 can be provided on the same layer or on a different layer. The extension direction of the electrical connection bridge 123 may form an angle with the second direction or may be parallel to the second direction. It can be understood that in order to avoid that the electrical connection bridges 123 connected to the entire second touch channel 120 are distributed in a line, the extension of the electrical connection bridge 123 can form an angle with the second direction, so that the electrical connection bridge 123 is arranged irregularly, to avoid that a plurality of electrical connection bridge 123 are regularly distributed on the touch panel 100 in a line, to weaken the degree of visualization of the electrical connection bridge 123.

In an embodiment, the extension direction of the electrical connection bridge 123 in the present application can form an acute angle with the second direction. In such arrangement, the electrical connection bridge 123 is not in a line with the second direction, thus when the second touch channel 120 is provided with a plurality of electrical connection bridges 123, the plurality of electrical connection bridges 123 will not be regularly distributed in a line, the visibility of the electrical connection bridges 123 observed by the user can be weaken. When there are provided two electrical connection bridges 123, the extension direction of at least two electrical connection bridges 123 can be the same or different, that is, at least two electrical connection bridges 123 can be parallel to each other, or can form an angle.

In the technical solution of the present application, the crossing unit 122 is provided between the two adjacent second electrode units 121 and insulated from the first touch channel 110, thus the two adjacent second electrode units 121 on the second touch channel 120 are connected to the crossing unit 122 through the electrical connection bridge 123, so that two adjacent second electrode unit 121 can be electrically connected through setting of the electrical connection bridge 123 and the crossing unit 122. In addition, by setting the crossing unit 122, two adjacent second electrode units 121 can be connected to the crossing unit 122 via the electrical connection bridge 123, instead of directly connecting two ends of the electrical connection bridge 123 to the two second electrode units 121 on both side of the crossing unit 122, to reduce a length of a single electrical connection bridge 123, and the extension direction of the electrical connection bridge 123 is at an acute angle to the second direction, the electrical connection bridges 123 are not distributed in a line, thus the visibility of the bridge 123 is weaken.

In an embodiment, an edge of the crossing unit 122 is at least partially surrounded by the first touch channel 110.

In an embodiment, all edges of the crossing unit 122 can be surrounded by the first touch channel 110, or only partial edges of the crossing unit 122 can be surrounded by the first touch channel 110. In such arrangement, so that a coupling capacitance can be formed between the crossing unit 122 and the first touch channel 110, to improve the capacity of the overall coupling capacitance, and thus when the user's finger touches the touch panel, the variation of the coupling capacitance is increased, and then the accuracy of touch is improved.

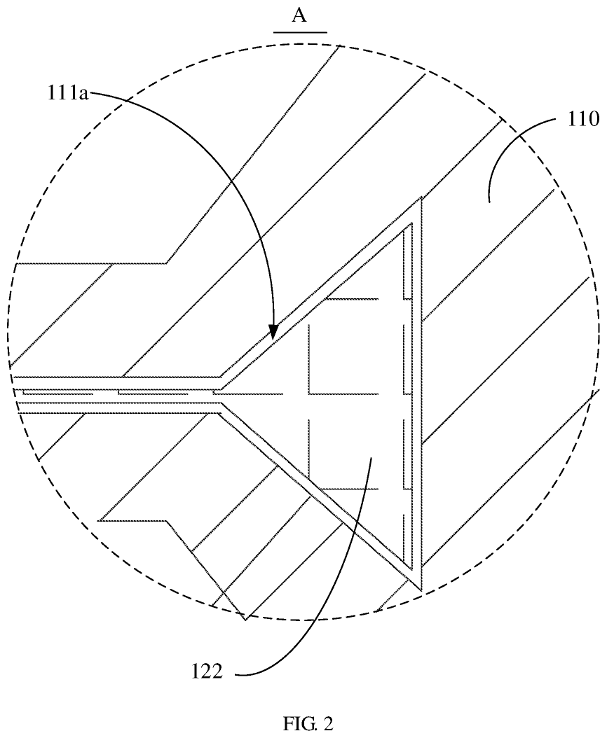

In some embodiments, please refer to FIG. 1 and FIG. 2, the first touch channel 110 is opened with an avoidance hole 111a, hole walls of the avoidance hole 111a are enclosed to form a closed space, the crossing unit 122 is provided in the closed space and a gap is provided between the crossing unit and the hole walls of the avoidance hole 111a.

Since the first touch channel 110 is opened in the avoidance hole 111a, the hole walls of the avoidance hole 111a are enclosed to form a closed space, the closed space is provided with a crossing unit 122, the crossing unit 122 and the first touch channel 110 are provided on the same layer, so that on the one hand, the crossing unit 122 will not occupy the area outside the first touch channel 110, the substrate is used reasonably. On the other hand, all edges of the crossing unit 122 are completely surrounded by the walls of the avoidance hole 111a in the first touch channel 110, the length of the edges of the crossing unit 122 and the first touch channel 110 near each other is increased, more coupling capacitance are provided between the opposite edges of the crossing unit 122 and the first touch channel 110, thus the variation of the coupling capacitance of the touch panel 100 is increased when the user touches the touch panel 100, so that the touch sensitivity of the touch panel 100 in the present application can be improved. It should be noted that the hole wall of the avoidance hole 111a is the edge of the first touch channel 110 near the crossing unit 122.

In an embodiment, in order to form the crossing unit 122 in the first touch channel 110 and make the crossing unit 122 insulated from the first touch channel 110, the present application can first lay a layer of electrodes to form the initial layer of electrodes, and then open the avoidance hole 111a in the first touch electrode, the avoidance hole 111a is channel-shaped of a closed graphic, so that the inner electrode formed by the enclosure of the avoidance hole 111a is the crossing unit 122, the area outside the graph formed by enclosure of the avoidance hole 111a is the first touch channel 110. Of course, the present application can also first lay a layer of electrodes to form the first touch electrode, and then open the avoidance hole 111a on the first touch electrode, and then in the avoidance hole 111a to lay the crossing electrode as the crossing unit 122, an insulating gap is formed between the crossing electrode and the wall of avoidance hole 111a.

In some embodiments, as shown in FIG. 1, each crossing unit 122 is connected with two electrical connection bridges 123, which are connected to the second electrode unit 121 on each side of the crossing unit 122, and the two electrical connection bridges 123 are provided at an angle.

It should be noted that the “provided at an angle” in the present application refers to the value of the angle other than 0°, 180°. The two electrical connection bridges 123 can be provided at an acute angle, at a right angle or at an obtuse angle. In the embodiment, two electrical connection bridge 123 connected to the crossing unit 122 is provided at an angle, so that the two adjacent electrical connection bridges 123 are inclined in different directions, and the two electrical connection bridge 123 must not be in the same line, so the arrangement of electrical connection bridge 123 then further weakens the visibility of electrical connection bridge 123.

In an embodiment, there is provided one, two or more crossing units 122, and when there are provided at least two the crossing units 122, these crossing units 122 are arranged at intervals in the second direction, and each crossing unit 122 is provided at intervals with a second electrode unit 121, so that each crossing unit 122 is connected to two electrical connection bridges 123. In such arrangement, a plurality of electrical connection bridges 123 are arranged in the second direction, where an angle can be formed between the two electrical connection bridges 123, or two adjacent electrical connection bridges 123 can also be provided in parallel to each other.

In an embodiment, as shown in FIG. 1, the first touch channel 110 includes at least two first electrode units 111 spaced in the first direction, two adjacent first electrode units 111 are connected by a connecting electrode 112, the connecting electrode 112 is spaced from the second electrode unit 121. The crossing unit 122 crosses the connecting electrode 112 and two first electrode units 111.

The crossing unit 122 crosses the connecting electrode 112 and the two first electrode units 111, the area of the crossing unit 122 surrounded by the first touch channel 110 is larger, thus the coupling capacitance between the crossing unit 122 and the first touch channel 110 is increased, and thus when the user touches with his finger, the variation of the coupling capacitance is bigger, the accuracy and response speed of the recognition of the first touch channel 110 and the second touch channel 120 to touch signals can be improved. In addition, the crossing unit 122 crosses the two first electrode units 111 and the connecting electrode 112, the second electrode unit 121 can be flexibly connected to any position of the crossing unit 122 through the electrical connection bridge 123, to provide more selectivity for the connection position of the electrical connection bridge 123 to weaken the visibility of the electrical connection bridge 123. The crossing units 122 may be distributed in a line, or an axisymmetric figure, the axis of symmetry of the axisymmetric figure is a midline of the connecting electrode 112 extending in the second direction.

In an embodiment, as shown in FIG. 1, the crossing unit 122 includes a first crossing portion 1221, a second crossing portion 1222, and a connecting portion 1223, the first crossing portion 1221 and the second crossing portion 1222 are surrounded by two adjacent first electrode units 111, respectively, and the connecting portion 1223 is surrounded by the connecting electrode 112 and connected to the first crossing portion 1221 and the second crossing portion 1222. The first crossing portion 1221 or the second crossing portion 1222 is connected to two electrical connection bridges 123.

Only one of the first crossing 1221 and the second crossing 1222 is connected to the two electrical connection bridges 123, more electrical connection bridges 123 are avoided, to reduce the density of electrical connection bridges 123 and further weaken the visibility of electrical connection bridges 123 on the entire touch panel 100.

In an embodiment, the shape of the first crossing portion 1221 and the second crossing portion 1222 can be the same or different. The shape of first crossing portion 1221 can be triangular, semi-circular, circular, rhombus or other polygonal shape. The shape of the second crossing 1222 can be triangular, semi-circular, circular, rhombus or other polygonal shape, etc.

In an embodiment, as shown in FIG. 1, there are at least two the first touch channels 110 and are provided at intervals with the second electrode unit 121. The first crossing portion 1221 of one of the two adjacent first touch channels 110 is electrically connected to the electrical connection bridge 123, and the second crossing 1222 of the other of the two adjacent first touch channels 110 is electrically connected to the electrical connection bridge 123.

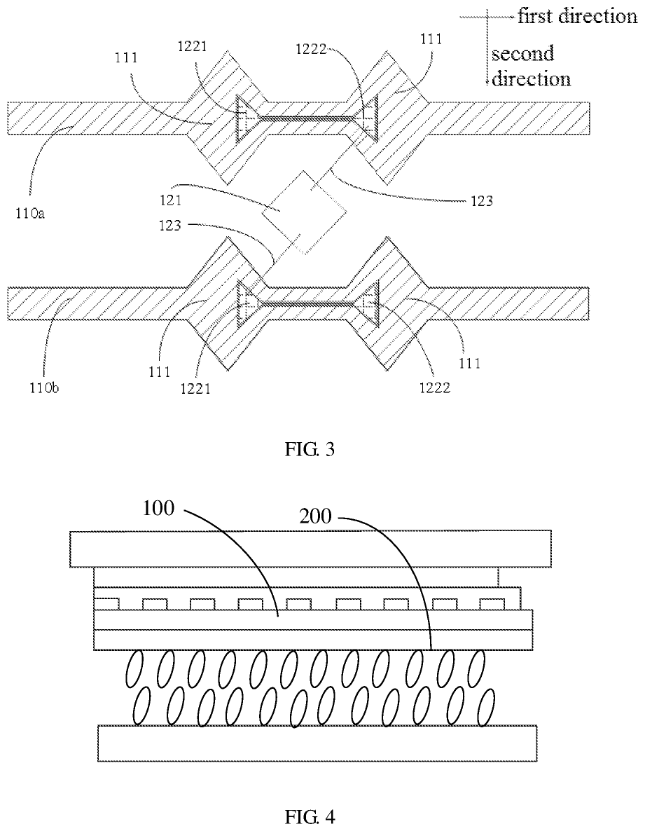

In an embodiment, as shown in FIG. 3, two adjacent first touch channels 110 are defined as an upper touch channel 110a and a lower touch channel 110b, and two adjacent first electrode units 111 in the upper touch channel 110a correspond to two adjacent first electrode units 111 in the lower touch channel 110b, so that four first electrode units 111 are arranged in a matrix, and a center of a matrix formed by the four first electrode units 111 is provided with a second electrode unit 121. The two first electrode units 111 in the upper touch channel 110a provided at intervals in the first direction are provided with the first crossing portion 1221 and the second crossing portion 1222 respectively, and the second crossing portion 1222 is electrically connected to an electrical connection bridge 123, and then is electrically connected to the second electrode unit 121 in the center of the above matrix through the electrical connection bridge 123. The two first electrode units 111 in the lower touch channel 110b provided at intervals in the first direction are also provided with a first crossing portion 1221 and a second crossing portion 1222 respectively. The first crossing portion 1221 in the left side of the lower touch channel 110b is electrically connected to another electrical connection bridge 123, and then is electrically connected to the second electrode unit 121 in the center of the matrix through the electrical connection bridge 123.

The first crossing portion 1221 of one of the two adjacent first touch channels 110 is connected to the electrical connection bridge 123, and the second crossing portion 1222 of the other one of the two adjacent first touch channels 110 is connected to the electrical connection bridge 123, a greater density of electrical connection bridges 123 in localized areas on the entire touch panel 100 is further avoided, to weaken the visibility of the electrical connection bridge 123 on the entire touch panel 100.

In an embodiment, as shown in FIG. 1, the two adjacent first electrode units 111 provided in the first direction are defined as the first sub-electrode unit and the second sub-electrode unit. The first crossing portion 1221 is provided on a side of the first sub-electrode unit near the second sub-electrode unit, and the second crossing portion 1222 is provided on a side of the second sub-electrode unit near the first sub-electrode unit.

In such arrangement, the first crossing portion 1221 and the second crossing portion 1222 are close to the second electrode unit 121, so that the length of the electrical connection bridge 123 is not too long when two ends of the electrical connection bridge 123 are connected to the second electrode unit 121 and the first crossing portion 1221 (or the second crossing portion 1222) respectively, thus the length of the electrical connection bridge 123 is shorten and the visibility of the single electrical connection bridge 123 is weaken.

In an embodiment, each first electrode unit 111 is surrounded by two crossing portions, the two crossing portions are spaced in the first direction, and the two crossing portions are electrically connected to two rows of second touch channels 120 through the two electrical connection bridges 123, respectively.

Since the two crossing portions in each first electrode unit 111 are electrically connected to two rows of the second touch channels 120, the coupling capacitance between each first electrode unit 111 and the crossing unit 122 is further improved, thus the response speed when user finger touch the touch panel 100 is improved. Two adjacent crossing portions in the each first electrode unit 111 can be formed as the first crossing portion 1221 in one of the two different crossing units 122 and the second crossing portion 1222 in the other one of the two different crossing units 122.

The present application also proposes a display module, as shown in FIG. 4, including a display panel 200 and a touch panel 100 as described above, the touch panel 100 is located on a light-emitting side of the display panel 200. The display panel has a display area, the display area corresponds to a location of a touch display area of the touch panel 100 for displaying images. It should be understood that by locating the touch panel 100 on the light-emitting side of the display panel 200, the touch panel 100 in the embodiment is external to the display panel 200.

Of course, in other embodiments, the touch panel 100 can also be embedded in the display panel 200, that is, the touch electrodes of the touch panel 100 (such as the first touch channel 110, the second touch channel 120, the crossing unit 122, etc.) are embedded in the display panel, to reduce a thickness of the display module.

The above mentioned is only a preferred embodiment of the present application, not to limit the scope of the patent of the present application. Any equivalent structural transformation made by using the specification of the present application and the drawings under the inventive concept of the present application, or direct/indirect application in other related technical fields are included in the scope of patent protection of the present application.

1. A touch panel, comprising a substrate, wherein the substrate is provided with a touch area, the touch area is provided with a first touch channel and a second touch channel, the first touch channel extends in a first direction, the second touch channel is insulated from the first touch channel;
wherein the second touch channel comprises at least two second electrode units spaced in a second direction, wherein the first direction intersects the second direction, the first touch channel is provided between two adjacent second electrode units and insulated from two adjacent second electrode units;
wherein the touch panel further comprises:
a crossing unit provided on the first touch channel and provided between two adjacent second electrode units, the crossing unit being insulated from the first touch channel; and
the crossing unit is connected with two electrical connection bridges, one electrical connection bridge is connected to the second electrode unit on one side of the crossing unit, the other electrical connection bridge is connected to the second electrode unit on the other side of the crossing unit, and an extension direction of the electrical connection bridge forming an acute angle with the second direction.

2. The touch panel according to claim 1, wherein edges of the crossing unit are at least partially surrounded by the first touch channel.

3. The touch panel according to claim 2, wherein the first touch channel is opened with an avoidance hole, hole walls of the avoidance hole are enclosed to form a closed space, the crossing unit is provided in the closed space, and a gap is provided between the crossing unit and the hole walls of the avoidance hole.

4. (canceled)

5. The touch panel according to claim 3, wherein the first touch channel comprises at least two first electrode units spaced in the first direction, two adjacent first electrode units are connected to each other by a connecting electrode, the connecting electrode is spaced from the second electrode unit, and the crossing unit crosses the connecting electrode and the two first electrode units.

6. The touch panel according to claim 5, wherein the crossing unit comprises a first crossing portion, a second crossing portion, and a connecting portion, the first crossing portion and the second crossing portion are surrounded by two adjacent first electrode units respectively, the connecting portion is surrounded by the connecting electrode and connects the first crossing portion and the second crossing portion, and two electrical connection bridges are connected to the first crossing portion or the second crossing portion.

7. The touch panel according to claim 6, wherein the touch panel comprises at least two first touch channels provided at intervals with the second electrode unit, the first crossing portion of one of two adjacent first touch channels is electrically connected to the electrical connection bridge, and the second crossing portion of the other of two adjacent first touch channels is electrically connected to the electrical connection bridge.

8. The touch panel according to claim 6, wherein two adjacent first electrode units in the first direction are defined as a first sub-electrode unit and a second sub-electrode unit, the first crossing portion is provided on a side of the first sub-electrode unit near the second sub-electrode unit, and the second crossing portion is provided on a side of the second sub-electrode unit near the first sub-electrode unit.

9. The touch panel according to claim 6, wherein the first electrode unit is of rhombus, polygon or circle; and/or
the second electrode unit is of rhombus, polygon or circle; and/or
the first crossing portion is of polygon, rhombus or circle; and/or
the second crossing portion is of polygon, rhombus or circle.

10. A display module, comprising a display panel and a touch panel, wherein the touch panel is located on a light emitting side of the display panel;
wherein the touch panel comprises a substrate, wherein the substrate is provided with a touch area, the touch area is provided with a first touch channel and a second touch channel, the first touch channel extends in a first direction, the second touch channel is insulated from the first touch channel;
wherein the second touch channel comprises at least two second electrode units spaced in a second direction, wherein the first direction intersects the second direction, the first touch channel is provided between two adjacent second electrode units and insulated from two adjacent second electrode units;
wherein the touch panel further comprises: a crossing unit provided on the the first touch channel and provided between two adjacent second electrode units, the crossing unit being insulated from the first touch channel; and
the crossing unit is connected with two electrical connection bridges, one electrical connection bridge is connected to the second electrode unit on one side of the crossing unit, the other electrical connection bridge is connected to the second electrode unit on the other side of the crossing unit, and an extension direction of the electrical connection bridge forming an acute angle with the second direction.

11. The display module according to claim 10, wherein edges of the crossing unit are at least partially surrounded by the first touch channel.

12. The display module according to claim 11, wherein the first touch channel is opened with an avoidance hole, hole walls of the avoidance hole are enclosed to form a closed space, the crossing unit is provided in the closed space, and a gap is provided between the crossing unit and the hole walls of the avoidance hole.

13. (canceled)

14. The display module according to claim 12, wherein the first touch channel comprises at least two first electrode units spaced in the first direction, two adjacent first electrode units are connected to each other by a connecting electrode, the connecting electrode is spaced from the second electrode unit, and the crossing unit crosses the connecting electrode and the two first electrode units.

15. The display module according to claim 14, wherein the crossing unit comprises a first crossing portion, a second crossing portion, and a connecting portion, the first crossing portion and the second crossing portion are surrounded by two adjacent first electrode units respectively, the connecting portion is surrounded by the connecting electrode and connects the first crossing portion and the second crossing portion, and two electrical connection bridges are connected to the first crossing portion or the second crossing portion.

16. The display module according to claim 15, wherein the touch panel comprises at least two first touch channels provided at intervals with the second electrode unit, the first crossing portion of one of two adjacent first touch channels is electrically connected to the electrical connection bridge, and the second crossing portion of the other of two adjacent first touch channels is electrically connected to the electrical connection bridge.
